(19) United States
(12) Patent Application Publication
(10) Pub. No.: US 2014/0244444 A1
(43) Pub. Date: Aug. 28, 2014

(54) Paperless Ticketing System

(71) Applicant: Guoyao Zhang, Stamford, CT (US)

(72) Inventor: Guoyao Zhang, Stamford, CT (US)

(21) Appl. No.: 13/780,712

(22) Filed: Feb. 28, 2013

(51) Int. Cl. G06Q 30/06

(52) U.S. Cl. CPC G06Q 30/0635
USPC 705/26.81

(57) ABSTRACT

A paperless ticketing program acts as an intermediary between existing concrete dispatch and concrete batching programs. The paperless ticketing program receives concrete ticket delivery information from the concrete dispatch program and batch weight information from the concrete batching program in order to create a paperless ticket. A paperless ticketing client runs on a portable computer having a touch screen interface to allow a customer to electronically sign the ticket to acknowledge receipt of a concrete delivery. The paperless ticketing program retrofits existing systems with paperless ticketing functionality.

### FIELD OF THE INVENTION

The present teachings relate generally to distribution systems and methods and, more particularly, to managing concrete delivery from concrete batch plants as well as the delivery of other bulk materials.

### BACKGROUND OF THE INVENTION

Concrete can be made in different mixes for different purposes. A concrete batch plant is where various ingredients are combined to make different batches of concrete. A customer may order an amount of a certain type of concrete and the order is then batched at the batch plant. The concrete is discharged into the truck, weighed (e.g., the batch weight), and sent to the customer for delivery.

Modern concrete batch plants employ computer programs to assist in managing the receipt of orders and distribution of concrete deliveries. These may involve two types of computer programs, namely, batching programs and dispatching programs. A batching program is typically used at the concrete plant to automate the batching of concrete. It may include functionality such as inventory tracking, distribution of tickets, and recording of batch weights. It may also have an interface for a dispatching program. A dispatching program is typically used to centrally receive and manage customer orders, which may then be fulfilled at multiple batch plants. It may include functionality such as the scheduling of orders and assigning of tickets to batch plants, and the sending of ticket information to a batching program.

Paper tickets have traditionally been used to assist with the distribution of concrete. A ticket may be assigned to a concrete truck and the concrete truck may be loaded according to the paper ticket and sent out for delivery. Once the load is delivered, the customer may sign the paper ticket to acknowledge receipt of the concrete delivery, and the paper ticket may be filed for future reference.

U.S. Pat. No. 7,246,009 to Hamblen, et al. discloses resource management system for concrete trucks. In particular, Hamblen is directed to using GPS sensors to track the real-time statuses of concrete trucks. Using Hamblen, a dispatcher can reroute trucks as necessary. Hamblen is a proprietary system having a dispatch server communicating with onboard computers mounted on trucks. Hamblen discloses one embodiment that utilizes a PDA to act as a communication channel between a data interface unit (and sensors) on the truck and a dispatcher. Hamblen's system is proprietary and complex. Specifically, it is not versatile and does not enable compatibility with existing systems or mobile devices.

Therefore, it would be beneficial to have a superior system and method for a paperless ticketing system. In particular, it is desirable to have a system that retrofits existing dispatch and/or batching programs with paperless ticketing functionality.

### SUMMARY OF THE INVENTION

The needs set forth herein as well as further and other needs and advantages are addressed by the present embodiments, which illustrate solutions and advantages described below.

The system of the present embodiment includes, but is not limited to, a paperless ticketing program executing on a first computer, the program having a system interface adapted to receive ticket information from a concrete dispatch program and batch information from a concrete batching program, a storage in electronic communication with the paperless ticketing program, the storage adapted to store the ticket information and the batch information, and a paperless ticketing client executing on a second computer, the paperless ticketing client in electronic communication with the first computer over a wireless network. The paperless ticketing client has a graphical user interface adapted to display a ticket comprising the ticket information and the batch information. The graphical user interface is adapted to allow a user to edit the ticket to indicate a concrete delivery has been made.

The method of the present embodiment includes, but is not limited to, the steps of providing a paperless ticketing program for execution on a first computer; receiving, with the paperless ticketing program, ticket information from a concrete dispatch program and batch information from a concrete batching program; storing the ticket information and the batch information on a storage in electronic communication with the paperless ticketing program over the Internet; providing a paperless ticketing client for execution on a second computer, the paperless ticketing client in electronic communication with the first computer over a wireless network; displaying, with the paperless ticketing client, a ticket using the ticket information and the batch information; and editing the ticket, with the paperless ticketing client, to indicate a concrete delivery has been made.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of one embodiment of a system according to the present teachings.

FIG. 2 is one embodiment of the graphical user interface of a batching program according to FIG. 1.

FIG. 3 is one embodiment of the graphical user interface of a dispatching program according to FIG. 1.

FIG. 4 is a schematic diagram of one embodiment of data flow according to FIG. 1.

FIGS. 5-10 are various embodiments of the graphical user interface of a paperless ticketing program according to FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

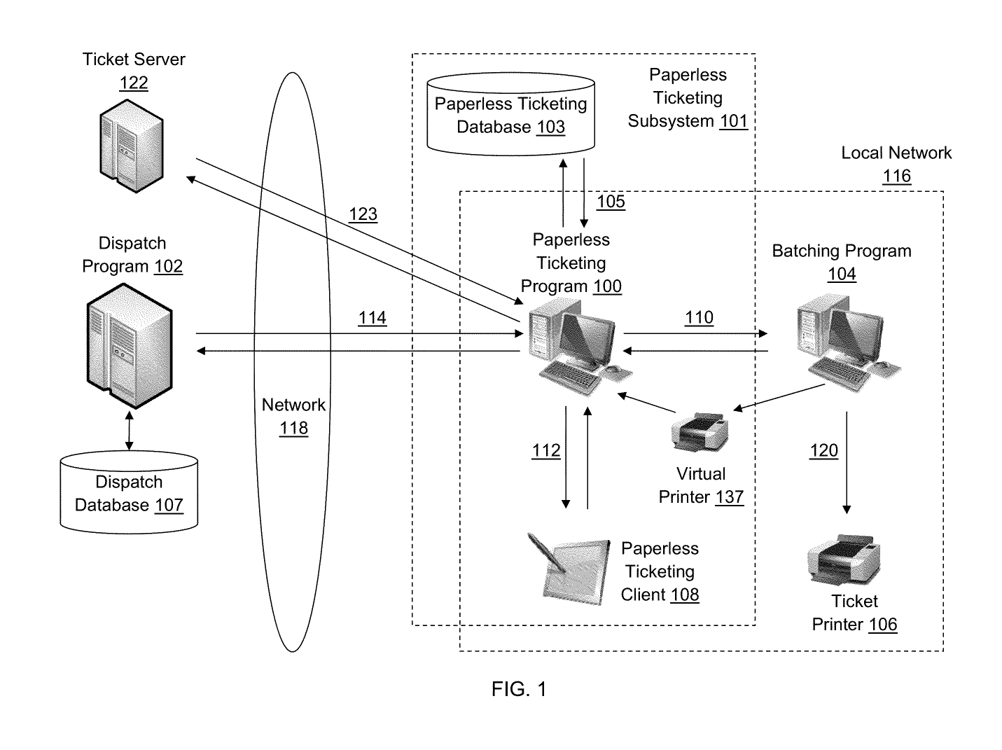

Referring to FIG. 1, shown is a schematic diagram of one embodiment of a system according to the present teachings. The system comprises a paperless ticketing program 100, which may act as a proxy (e.g., interface, intermediary, etc.) between existing dispatching 102 and batching 104 programs. The paperless ticketing program 100 may allow information to pass while at the same time providing paperless ticketing functionality. This way, the present system can be used to retrofit existing systems with the advantages of paperless ticketing. As a result, it may not require extra licenses from dispatch and batching system vendors.

Tickets are used in the concrete supply and bulk material industries as evidence that a concrete supplier has provided concrete to a customer. Information on tickets may include order number, ticket number, customer name, delivery address, time, concrete type, concrete amount, concrete quality and price, and tax information, although not limited thereto. Customers may be required to sign the ticket to prove that they received the concrete. Electric tickets such as those provided by the present teachings are designed to replace paper tickets and may not only save paper but also increase efficiency in the concrete delivery process.

The paperless ticketing program 100 and its related functionality may form a paperless ticketing subsystem 101. Such a subsystem may include a paperless ticketing database 103, which may be in the “cloud” and store data and functionality for paperless ticketing, including ticket information, truck information, and customer information, although not limited thereto. As used herein, the term “database” is generic for any suitable form of electronic storage and may include multiple databases. The paperless ticketing database 103 may be accessible over a network 118 such as the Internet, although not limited thereto, to allow for centralized access of paperless ticketing data and functionality. For example, in one embodiment, it may provide for Internet-based (e.g., web-based, etc.) accessibility (e.g., functionality, access to data, etc.), although not limited thereto,

A ticket server 122 may send/receive 123 data to/from the paperless ticketing subsystem 101 (e.g., paperless ticketing program 100, etc.). In one embodiment, the ticket server 122 may be a repository for tickets and owned/hosted/controlled by a customer. For example, it may comprise an FTP server where tickets are stored, although not limited thereto. The ticket server 122 may communicate with the paperless ticketing program over a network 118 such as the Internet. In another embodiment, the ticket server 122 may comprise the same computer as the paperless ticketing database 103, although not limited thereto. As used herein, the term “computer” is generic for any suitable form of electronic device and may include multiple computers.

In one embodiment, when the paperless ticketing program 100 receives a ticket, it may create a file (e.g., a .pdf document, etc.) of the ticket. This may be referred to as a “pending” file. “Pending” ticket files may include tickets received by the batching program to be fulfilled by an associated plant. The paperless ticketing program 100 may send this “pending” file to the desired ticket server 122 for storage and accessibility by the customer. Accounting personnel can review these files to check how many tickets were received by the plant.

If a ticket is deleted, the paperless ticketing program 100 may send a “void” ticket file to the ticket server 122, which may replace a “pending” file. A new file with “VOID” watermark in the content may be created and uploaded to a pending folder on the ticket server, although not limited thereto. “Void” ticket files may indicate those tickets that have been deleted (e.g., order cancelled, etc.) in the dispatch program 102. The paperless ticketing program 100 may retrieve signed (e.g., “completed”) tickets. These may include customer signatures and other ticket information from the paperless ticketing database 103. The paperless ticketing program 100 may create a “complete” file and send it to the ticket server 122. “Completed” ticket files may indicate tickets that have been batched and delivered.

A system according to the present teachings provides a number of advantages. The paperless ticket program 100 may work as a proxy between the dispatch program 102 and the batching program 104 to capture any data transferred between them, including ticket data and batch weights data. As a result, the paperless ticket program 100 can work with any vendor's dispatch system and batch system. All that may be needed is that they support a standard communication protocol. In addition, there is no need to modify an existing dispatch system or batch system in order to make it work with the paperless ticket program 100. Further, the paperless ticket program 100 can capture any activities between dispatch and batch and act upon those activities, including ticket print, ticket reprint, ticket removal, batch weights, etc.

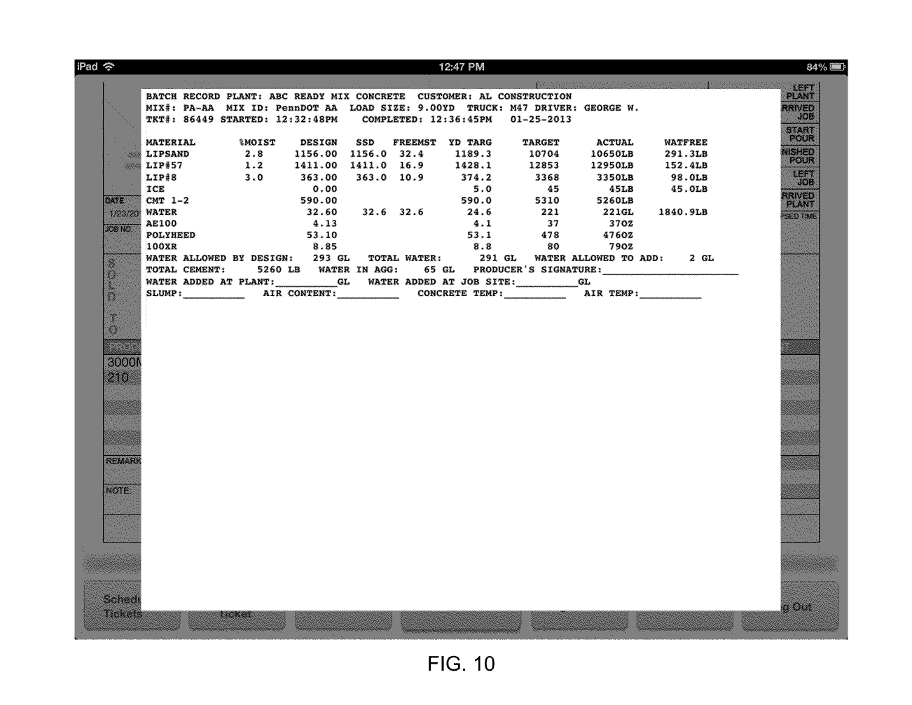

In one embodiment, a virtual printer 137 installed on a computer with the batching program 104 may help with the capture of batch records (e.g., batch information) (shown in FIG. 10). In this way, the system can keep the batch system's original batch record format. This may be important to meet the customer's requirements (e.g., state DOT special requirements, etc.). The virtual printer 137 may work with any vendor's batch system. It may be able to print batch records, which contain far more batch information that just batch weights. It may also make use of a batch system's batch record format customization capability.

The paperless ticket program 100 may pull batch record information (e.g., weights, etc.) from a batching program 104 as frequently as desired by the user. It may cache the information for the dispatch program 102 instead of waiting for the dispatch program 102 to request batch weights, which may occur at a longer interval. This way, the batch weights may be available a lot faster and the truck driver can leave the plant quicker, improving productivity.

Additional functionality may improve system efficiency. In one embodiment, the paperless ticketing program 100 may send the job destination to the paperless ticketing client 108. The paperless ticketing client 108 may generate a map of the destination, which provides the route from plant to the job location as a driving direction assistant.

The paperless ticketing client 108 may enable GPS functionality to update ticket status automatically. Mobile devices embedded with GPS receiver modules can provide geographic locations of delivery trucks. The paperless ticketing client 108 may send the geographic location information to the paperless ticketing program 100. The paperless ticketing program 100 may update the paperless ticketing database 103 and calculate the truck status according to a “geo-fence” comprising the destination and plant location. Then the paperless ticketing program 100 may send the truck status back to the paperless ticketing clients 108, which may update the ticket status on the device screen.

The department of transportation requires a number of forms for each truck. Different states also require different forms. In one embodiment, the paperless ticketing program 100 may have an “Add a Form” interface, which allows a user to upload (e.g., create, etc.) customized forms for use with paperless ticket clients 108. Truck drivers may input truck information into these forms and submit forms to the paperless ticketing program 100 through a wireless network connection. The paperless ticketing program 100 may generate a file (e.g., PDF format, etc.) for each form submitted and users can print out these files using traditional printers, although not limited thereto.

Traditional batching programs 104 are used in any number of different types of concrete batch plants to manage concrete production. For example, they may be used in dry batch plants (e.g., accumulative, decumulative, etc.), wet batch plants, wet/dry combination plants, precast/prestress plants, block plants, pipe plants, and asphalt plants, among others. The batching program 104 may receive tickets and send batch commands to a batch panel according to tickets.

Concrete batching programs 104 may include manual control buttons to control batch functions such as the release of concrete into a concrete truck. They may also be automated but allow the operator to interrupt the automation cycle any time, while retaining the cycle and its batch records. Remote batching features may allow an operator to initiate jobs at an unattended plant. With a high speed network access (e.g., over the Internet, etc.), there may be no restriction in distance or cost for a user to have a mirror system to monitor the operation or “assume command” of a batching program 104 at a batch plant.

One provider of batching programs is Sysdyne, which provides the TrailBlazer™ software product. In one configuration, TrailBlazer includes a compact desktop manual control console, a wall mount junction box, batching software, a monitor and a printer (for multi-copy ticket printing, etc.). TrailBlazer provides a flexible system that helps to increase efficiency and productivity in batch plants and is compliant with D.O.T. regulations.

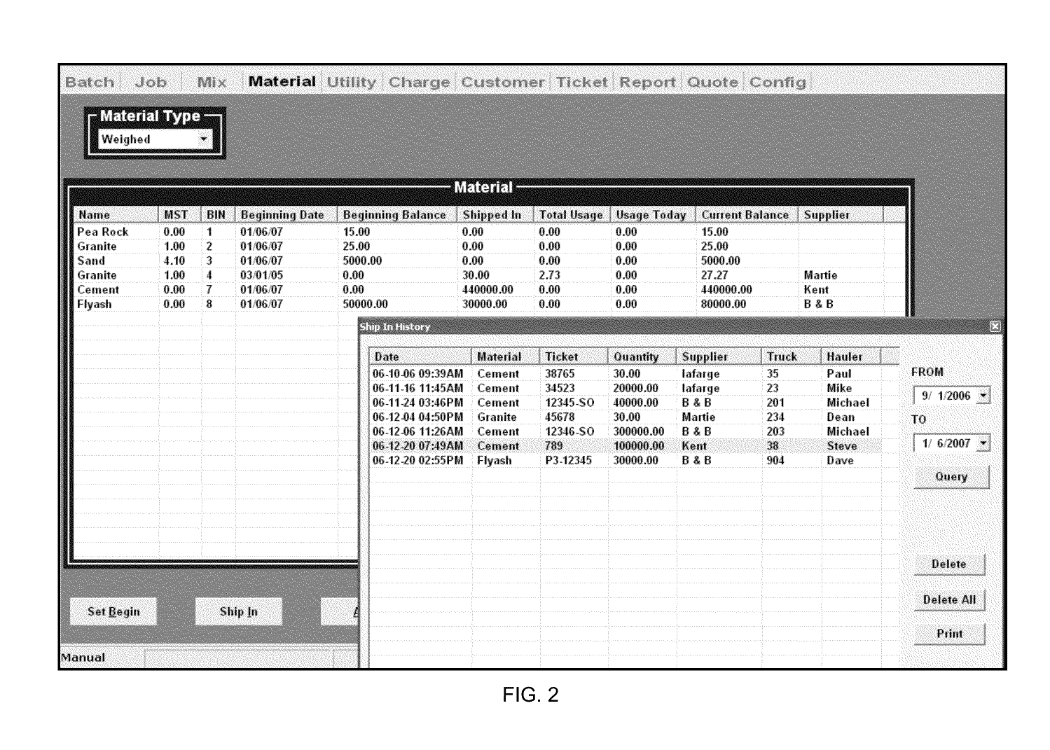

Referring to FIG. 2, shown is one embodiment of the graphical user interface of a batching program 104 according to FIG. 1. Using the batching program, an operator can perform a number of concrete producer functions, including order entry, job scheduling, ticketing, reports, etc. The batching program may provide an intuitive main screen. Screen icons may be easily relocated for the operator's visual preference by using the “point, click and drag” method, although not limited thereto. In this way, batching functions may be available at a glance, and every on-screen button may be active and clickable. Manual backup systems may also be provided (e.g., control console with 110 VAC push buttons and selective switches, etc.).

Inventory tracking may not only assist with automated batches, but also when the operator pushes manual buttons to load trucks, so that the batching system may track both automatic and manual batches. In this way, a batching program 104 may provide for concrete plant inventory and batch recording, although not limited thereto.

A batching program 104 may also provide security and accountability functionality. For example, layered passwords may be utilized to assign different access levels to different users. This provides flexibility to include or exclude categories to each user.

A batching program 104 may also provide management reports according to a specific time period, although not limited thereto, including: plant analysis, material requirements, production of trucks, drivers, salesman, etc. Because batching records may be stored electronically (e.g., in storage such as a database, etc.), robust reporting may allow a user (e.g., an administrator, etc.) to specify the time period of any records: tickets, batch weights, inventory, etc. Further, it is possible to track data going back years, including inventory for all materials with detailed ship-in history of each material, although not limited thereto. Reports may be exported in multiple formats (e.g., excel spreadsheet, etc.), sent in electronic format to predetermined recipients, and/or printed on a printer.

The batching program 104 may also interface with other software systems, such as accounting, dispatching, truck tracking and other management software. The batching program 104 may interface with a dispatching program 102 for the exchange of data. With network access, a user may monitor a batching operation anytime from anywhere in the world.

Sysdyne also provides a dispatching program called ConcreteGo.com, which enables concrete producers to increase productivity, ensure on-time delivery, reduce delivery costs, improve cooperation among multiple facilities, decrease dispatchers' workloads and enhance communication between management and production personnel, among other things. The program provides order entry and ticketing. For example, it keeps a log of order entry activities by every user under an orders tab. A user may quickly enter orders without digging through multiple windows. The program may also allow the editing of pricing information as well as invoicing.

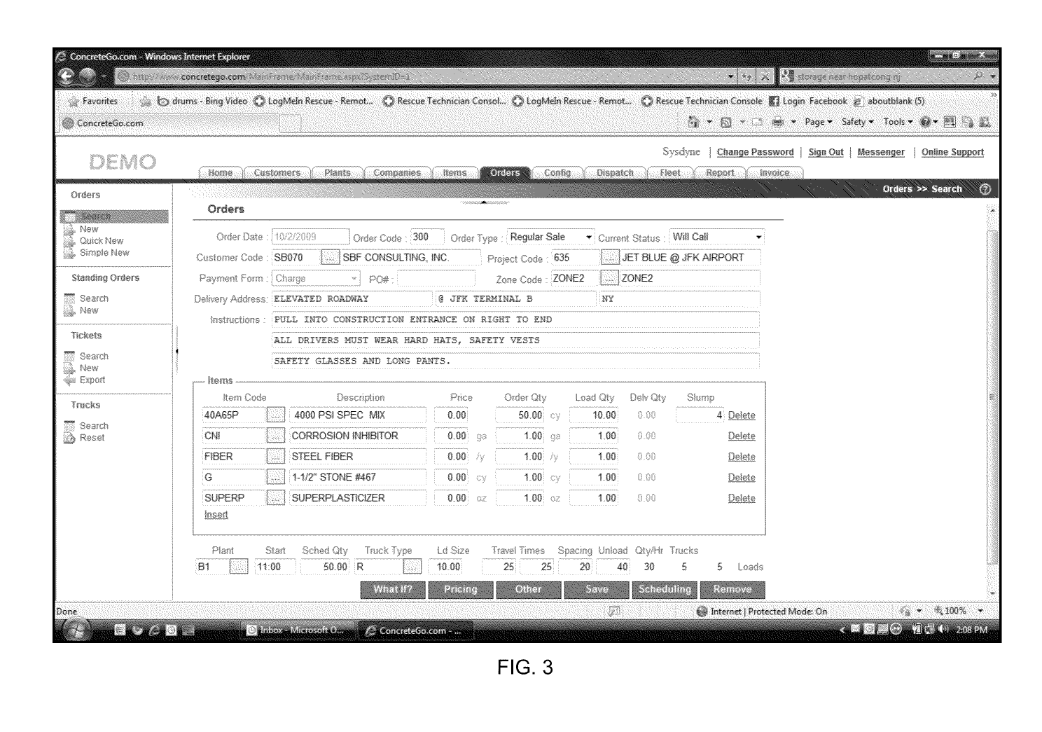

Referring to FIG. 3, shown is one embodiment of the graphical user interface of a dispatching program 102 according to FIG. 1. A dispatching program 102 may provide for tracking and scheduling, among other things. For example, scheduling functionality may provide information on the production at each batch plant and overall order fulfillment. The dispatcher/user may perform a number of tasks including ticketing an order, editing orders and order statuses, and checking load times, delivered quantities and order quantities, among others.

The dispatching program 102 may allow a dispatcher to see if there is a slot for a new order or the time frame that best suits a new order. “Standing Orders” functionality may automatically schedule repeat orders for a date range. Search functionality may retrieve orders and tickets by date, plant, customer, delivery address or product, although not limited thereto. A customizable ticket format can also be formatted to pre-printed tickets. The same ticket may be sent to batch controls and printers at the same time.

Truck tracking may also be performed to monitor a truck fleet. The dispatching program 102 may provide travel estimates, mapping orders and truck tracking. A dispatcher can edit, map, ticket or copy an order and show all loads of the order. Dispatchers can also easily manage their orders by choosing different color indicators to display orders, plants, trucks, jobs and customers. They can also create custom tracking screens to view only certain plants. Reminders may be provided to ticket a next order and check truck availability so that the dispatcher is always aware of the schedule.

An estimated travel time may be generated as soon as an order and delivery address is entered. This may interact with GPS information on the truck to achieve better accuracy. A detailed map with driving directions is available for printing. With GPS technology, dispatchers can track their entire fleet on a particular project. Even without GPS, a dispatcher can refresh a truck's status in accordance with verbal updates from the truck driver. If linked with truck signaling products, the tracking screen may display a truck's status when the driver pushes the “Status” button on the signaling device.

The dispatching program 102 may also provide robust management reports. For example, a schedule report may provide a summary of daily production of each plant and the total number of trucks an order demanded. Once a load is ticketed, the system may generate load sheets with a snapshot of how an order is being filled throughout the day. This provides the number of loads delivered to a project at any given time on a load sheet. Plant analysis reporting may compare the target and actual weights of each load. Reports may be generated in various formats and customized for different groups of users, and can be distributed or exported to users in multiple formats.

The dispatching program 102 may illustrate the trucks needed to fulfill the demands of orders for a given date, time period, plant, or order type, although not limited thereto. As the work day proceeds, a graph may dynamically adjust to reflect changes. Clicking or moving a cursor over the graph may bring up information regarding the orders and loads in that section. An interactive graph may also allow dispatch personnel to click and drag orders to see which time frames best suit upcoming orders. Dispatch personnel may adjust scheduling properties of an order, change an order to another plant, or split an order between multiple batch plants.

The dispatching program 102 may also provide for instant messaging, enabling users to communicate with each other and significantly reducing the volume of phone calls and increasing communication efficiency. Dispatchers can use the messenger to send messages directly to truck drivers through networked truck devices.

The dispatching program 102 may have an interface that allows software and services from different companies and locations to be combined easily to provide an integrated service to users. For example, integrating billing with central dispatch may be accomplished to simplify invoicing. Services such as OpenERP.com may be utilized, although not limited thereto, which provide an online open-source enterprise resource planning (ERP) system with accounting and back-office services. However, any commercial ERP or other business software (e.g., accounting, payroll, etc.) may be used with the present teachings to assist with managing a concrete distribution business.

The dispatching program 102 may also interface with batch controls. A two-way interface may enable connection with various batch control products. Using the interface, a dispatcher may send mix designs, ticketing orders with new mixes, and extracting batch weights, although not limited thereto. A dispatcher may also route an order directly to a printer to print a delivery ticket.

Referring again to FIG. 1, the dispatch 102 and batching 104 programs may communicate with each other over a network 118 such as the Internet, although not limited thereto. In one embodiment, the dispatch program 102 may allow a dispatcher to coordinate batching programs 104 at multiple concrete batch plants. In this way, the dispatch program 102 may provide for centralized order receipt and distribute orders out to available batch plants. The dispatch program 102 may send/receive data from a dispatch database 107, although not limited thereto, where data such as ticket information may be stored.

The paperless ticketing program 100 may act as an interface (e.g., intermediary, etc.) between the dispatch program 102 and batching program 104, although not limited thereto. In one embodiment, the paperless ticketing program 100 may not modify information 114,110, but copy the ticket information and batching information. The dispatch system 102 may send ticket information to the paperless ticketing program 100, which may reside on the same computer as the batching program 104 or another computer, although not limited thereto. In one embodiment, the paperless ticketing program 100 and the batching program 104 may be on the same local network 116, although not limited thereto. The paperless ticketing program 100 may then send (e.g., wired, wirelessly, etc.) the ticket information to the batching program 104. The paperless ticketing program 100 may also receive batch record information (e.g., batch weight information, etc.) from the batching program 104, and send this information to the dispatch program 102.

After a ticket is received at a batch plant, a paper ticket will traditionally be printed when the batch cycle starts. The batch records (if requested) are traditionally printed when concrete batching completes. Then both tickets and batch records will be distributed to assigned concrete truck.

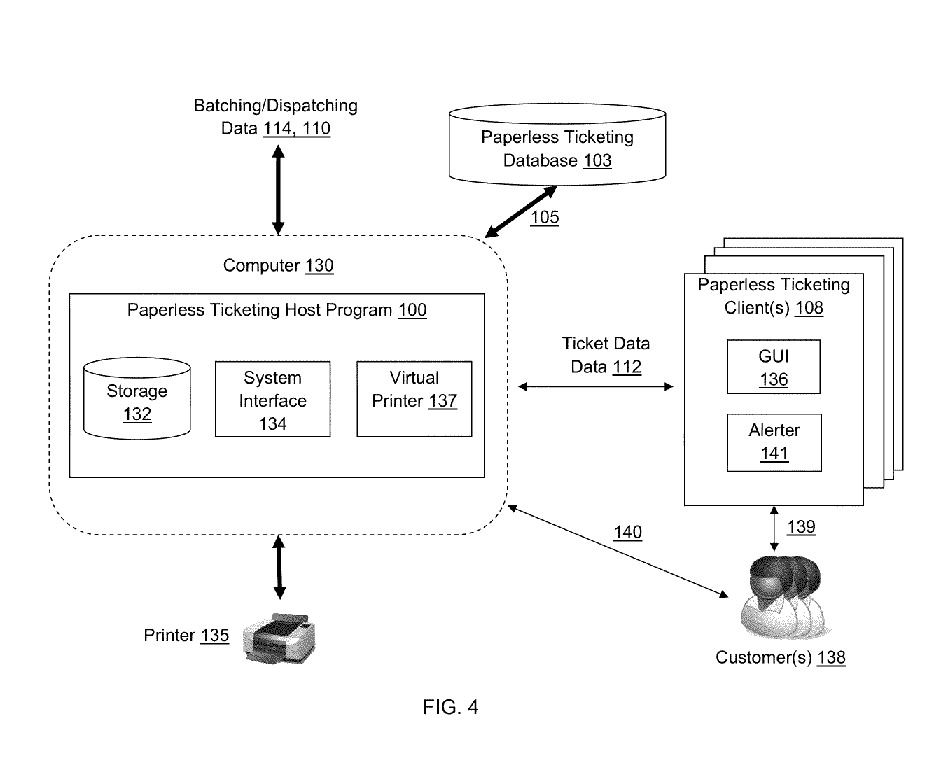

It is to be appreciated that acting as an intermediary between the two programs allows the paperless ticketing program 100 to have all of the information available from the two systems. In one embodiment, the batching program 104 may be in electronic communication (whether wired, wireless or otherwise) with a virtual printer 137 (shown in FIG. 4.). The paperless ticking program 100 may have a virtual printer 137, although not limited thereto. The virtual printer 137 may in the alternative reside on the batching or dispatching computer or some other computer. In a preferred embodiment, the paperless ticketing program 100 may create a virtual printer 137 on the computer running batching program 104, although not limited thereto.

Using the virtual printer 137, a paperless batch records (shown in FIG. 10) may be “printed” for distribution to one or more client 108. For example, the batching program 104 may “print” a ticket with batch weights for the paperless ticketing program 100, although not limited thereto. The paperless ticketing program 100 may receive the “printed” content from the batching program 104 and upload it to the paperless ticketing database 103. The virtual printer 137 may have settings including Company Code and Plant Code, although not limited thereto, which may be used to identify the plant for batch weights and corresponding tickets.

In one embodiment, the virtual printer 137 may allow the paperless ticketing client 108 to get ticket information even if there is no batching system. If there is no batching system, the dispatch system can send ticket to the virtual printer 137, and the paperless ticketing program 100 can get the ticket information from the printer.

Use of a virtual printer 137 has a number of advantages. For example, the virtual printer 137 can keep a batching program's 104 original batch record format that meets customer requirements (e.g., DOT special requirements, etc.) In addition, the paperless ticketing program 100 may allow a user to specify particular formatting preferences and reformat any data to a desired format. The paperless ticketing database 103, may store user/company/customer/etc. preferences, although not limited thereto.

The virtual printer 137 can print far more information that just batch weights. Further, the virtual printer 137 allows the system to work with any vendor's batch system. Further still, the virtual printer 137 makes use of the batch system's batch record format customization capability.

In one embodiment, the paperless ticketing program 100 may send a request for batch weights to the batching program 104 at predetermined times (e.g., every 10 seconds, etc.). If batch weights are available, the batching program 104 may sends batch weights to the paperless ticketing program 100. The paperless ticketing program 100 may store batch weights and send a copy to the paperless ticketing database 103. The paperless ticketing program 100 may also send batch weights to the paperless ticketing clients 108.

In one embodiment, the dispatch program 102 may request batch weights. Requests may be received by the paperless ticketing program 100. The paperless ticketing program 100 may first check to see if it has batch weights stored and available to respond to the request, in which case it will send it to dispatch program 102. Otherwise, the paperless ticketing program 100 may pass the request to the batching program 104.

In one embodiment, the system according to the present teachings may not require a batching program 104. In this scenario, the plant typically would print paper tickets using ticket information received from a dispatch program 102. The paperless ticketing program 100 may connect to a printer 106 or use a virtual printer 137 to print tickets, although not limited thereto.

Referring to FIG. 4, shown is a schematic diagram of one embodiment of data flow according to FIG. 1. The paperless ticketing program 100 may reside on one or more computers 130. All of the functionality disclosed herein may be implemented in hardware, software code executing on machine readable medium, or a combination thereof, and the present teachings are not limited to any particular embodiment. The paperless ticketing program 100 may receive and/or transmit data 114,110 back and forth with a batching program 104 and/or a dispatching program 102.

In one exemplary embodiment, the dispatcher using a dispatch program 102 may receive an order and assign a ticket to a particular truck/driver at a batch plant. The ticket may then be distributed 114 to the batching program 104 and distributed to the truck/driver. The paperless ticketing program may act as the intermediary between the two programs (or there may be no dispatch or batch program) and may receive the ticket information and forward it 110 to the batching program 104. The batch operator may call each truck/driver to be loaded according to ticket information.

The paperless ticketing program 100 may also receive and/or transmit data 112 back and forth with one or more paperless ticketing clients 108. Paperless ticketing clients 108 may, for example, be portable computers, laptops, notebook computers, iPads, smart phones, BlackBerries, iPhones, or some other equipment capable of receiving and/or transmitting data and the present teachings are not limited to any particular embodiment disclosed herein.

In a preferred embodiment, the paperless ticketing client 108 program may be provided for download from the Internet. For example, it may be provided on a website or an application marketplace (e.g., App Store, Google Play, etc.). In another embodiment, the paperless ticketing client 108 may be an interface served by the paperless ticketing program 100 but accessible to a client device. For example, it may be a web site or some other public interface (e.g., APIs, etc.). All that may be required is that the paperless ticketing client 108 has a graphical user interface for accessing information served by the paperless ticketing program 100 and the present teachings are not limited to any particular embodiment disclosed herein.

Once installed on a device, the paperless ticketing client 108 may be configured to communicate with the paperless ticketing program 100. Security may include the ability to set up user accounts. For example, an administrator may set up username/password combinations for a new user. When connected to a network, the paperless ticketing client 108 may search the local network 116 (shown in FIG. 1) for a paperless ticketing program 100. The user may then enter in log in credentials to set up communication between the paperless ticketing client 108 and the paperless ticketing program 100. In another embodiment, the user may provide information to locate the paperless ticketing program 100 such as an IP address, network name, or some other identifier, although not limited thereto.

In a further embodiment, the system may provide central storage of information regarding paperless ticketing programs 100. The paperless ticketing client 108 may be pre-configured to contact the central storage, where the user can provide search criteria (e.g., company name, location, etc.) to obtain information that will allow the paperless ticketing client 108 to connect with the paperless ticketing program 100. This may be provided by a paperless ticketing database 103, although not limited thereto. In such a way, the system may provide for access over a network (e.g., Internet, etc.) for centralized data and functionality. Data may be transmitted 105 back and forth.

In one embodiment, the paperless ticketing client 108 is associated with one or more paperless ticketing programs 100 as well as a concrete truck and/or a truck driver. This may provide the ability to assign paperless tickets to particular concrete truck and/or driver for fulfillment and delivery, although not limited thereto.

A “universal link” protocol may be used for communication among computers in the system and/or with different systems. In this way, the paperless ticketing program 100 and/or the paperless ticketing client 108 may support a number of other programs and data formats from different vendors. Data transmitted over a network may be encrypted and secured (e.g., by HTTPS or some other protocol, etc.), although not limited thereto. Administrators may define access rights for each user. This allows interaction from different user groups such as dispatch personnel, batch personnel, managers, truck drivers, senior executives and sales representatives.

In one embodiment the paperless ticketing client 108 may allow for printing capabilities. This may be preferable if, for example, a customer would like a paper receipt. A printer (e.g., portable, etc.) may provide for the ability to print out a ticket receipt to provide the customer. This may allow the user to print information of ticket and batch records (e.g., ticket number, truck number, item code, batch weight, amount, delivery time(s), etc.) through a wired or wireless (e.g., Bluetooth, etc.) print device. The truck may have its own printer or may utilize one at the delivery location, although not limited thereto.

The paperless ticking program 100 may be in electronic communication with storage 132 (e.g., database(s), etc.) where information can be stored which is helpful to the program. For example, the storage 132 may store ticket information and/or virtually printed tickets, although not limited thereto. Misc. information that the storage 132 may store includes Company Code, Plant Code, Plant Address, Batch computer IP address, Batch Program Port, Dispatch program listening port, FTP server IP address, FTP server username and password, although not limited thereto. For example, the Company Code and Plant Code may be used together to identify each plant and each ticket may contain a Company-Plant Code to identify which plant it belongs to.

The paperless ticking program 100 may also include a system interface 134, which may be implemented in software and/or hardware. System interface 134 may facilitate communication with batching 104 and dispatching 102 programs, clients 108, databases 103, and physical printers 135, although not limited thereto. One skilled in the art would appreciate that system interface 134 may provide for communication with any number of different devices and systems and the present teachings are not limited thereto. What is desired is that system interface 134 allow for the transfer of data, whether over a wired or wireless connection.

In one embodiment, the system interface 134 may also comprise a graphical user interface (GUI) to allow paperless ticketing client(s) 108 to access system data and functionality. In an alternative embodiment, the paperless ticketing client(s) 108 may have a GUI 136. This allows the user of the paperless ticketing client 108 to access the system, discussed further below. In addition, upon concrete delivery, customers 138 may sign a ticket to acknowledge receipt 139. A copy of the ticket can also be sent 140 (e.g., via email, etc.) to customers 138. Customer contact information may in one embodiment be retrieved from a dispatch database 107, although not limited thereto.

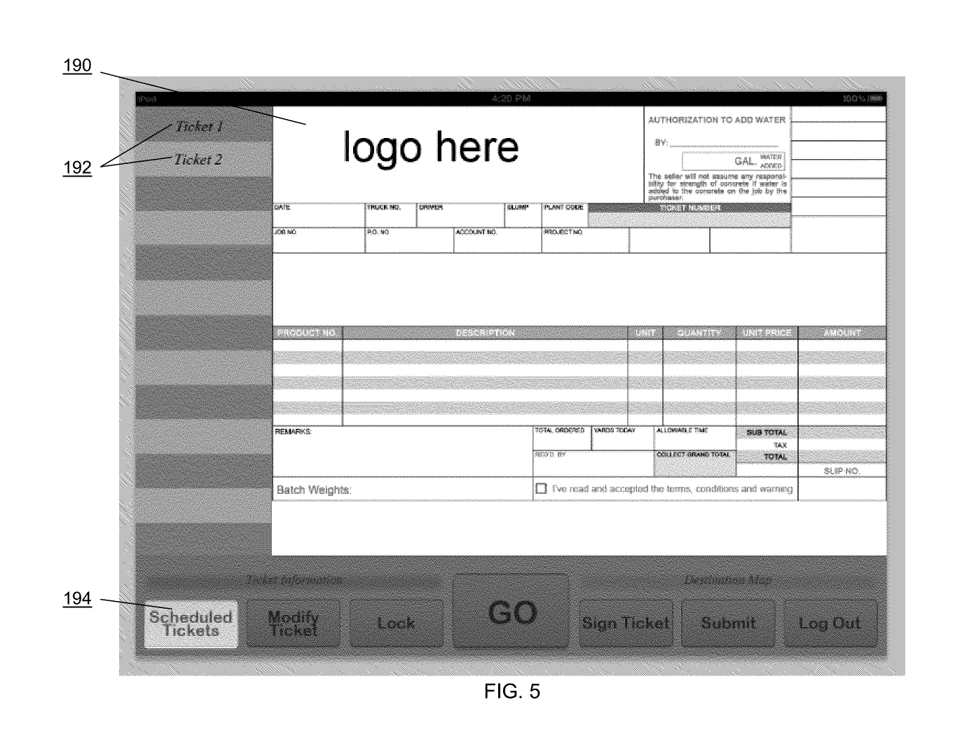

Referring to FIGS. 5-10, shown are various embodiments of the graphical user interface (GUI) of a paperless ticketing program 100 according to FIG. 1. In one embodiment, the GUI may be provided on a paperless ticketing client 108 (e.g., website, app, etc.). Functionality may include login, schedule tickets, modify tickets, sign ticket, submit, etc. A ticket 190 may be provided on a wireless device such as a smart phone (e.g., iPhone, BlackBerry, etc.), laptop, tablet (e.g., iPad, etc.), although not limited thereto. In this way, it may be used by the concrete truck driver to assist in managing concrete deliveries.

Referring to FIG. 5, the interface may have a “scheduled tickets” button 194 that provides a list 192 of all available tickets for a particular paperless ticketing client 108 (e.g., truck, driver, etc.). In one embodiment, the system may send requests to the server to check whether there are new tickets at predetermined times (e.g., every 30 seconds, etc.). If multiple servers are available, it may check for new tickets on every server. If there is a new ticket, it may download it from the server.

In one embodiment, the paperless ticketing program 100 may always listen to (or periodically connect with) the dispatch program 102 (e.g., monitor dispatch computer TCP port, etc.) and/or connect with dispatch database 107 to get any new tickets. As an intermediary, the paperless ticketing program 100 may connect with and send new tickets to the batching program 104. If the paperless ticketing program 100 receives a ticket, it may make a copy of the ticket and create a “pending” ticket file (e.g., a .pdf document, etc.). Then the paperless ticketing program 100 may upload the ticket file to the ticket server 122 and send the ticket information to the batching program 104, paperless ticketing database 103 and/or paperless ticketing client(s) 108. Then the paperless ticketing program 100 may revert back to a listen state and continue wait for the next ticket.

After receiving a ticket, the paperless ticketing program 100 may check the integrity of the ticket (e.g., CRC or other error detection mechanism, etc.) and record the time of receiving. New tickets may be added into the schedule ticket list 192. The ticket with the closest loading time may be loaded by default. In one embodiment, the system may track the following times: left plant, arrived at job, began pour, left job, arrived at plant. If there is an available batch weight for a specific ticket, it may be downloaded and rendered on the screen.

In one embodiment, the paperless ticketing program 100 may connect to the batching program 104 and request batch weights. A request may be made via a standard U-Link message that asks the batching program 104 to send batch weights, although not limited thereto. If the batching program 104 has batch weights, it may send them to the paperless ticketing program 100. When the dispatch program 102 requests batch weights, the paperless ticketing program 100 may check whether it has any batch weights first. If not, the paperless ticketing program 100 may forward the request to the batching program 104. The time between batch weights requests from the dispatch program 102 is typically set to a value of around 1 minute, which means truck drivers have to wait an average of 30 seconds after concrete batching is completed. In order to reduce waiting time of truck drivers, the paperless ticketing program 100 may initiate a batch weights request at a lower interval (e.g. 10 seconds). This may be a user setting. By requesting the batch weights from the batching program 104 and storing them in an accessible storage, the paperless ticketing program 100 will have this information readily available, for example, to respond to a request by the dispatch program 102.

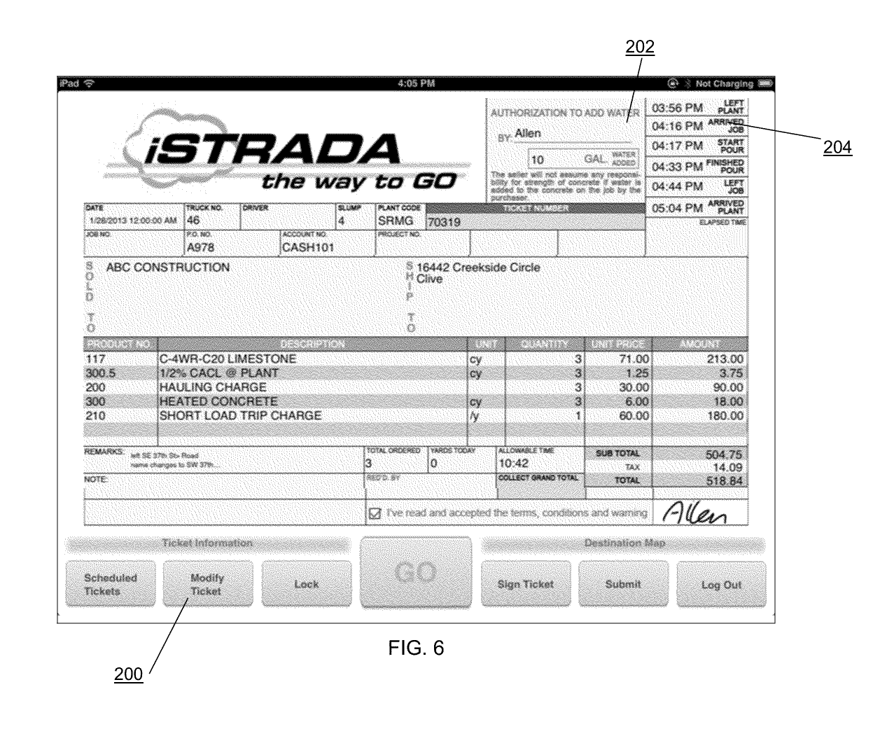

Referring to FIG. 6, shown is one embodiment of the graphical user interface for modifying a ticket. The ability to modify a ticket 200 may allow the driver to add information. For example, the driver may add comments on ticket. The driver may also change the batch weight based on available inventory, although not limited thereto. The system may record any changes the driver makes to provide accountability and reporting capabilities and the present teachings are not limited to any particular embodiment disclosed herein. The time 204 of each event may be recorded for later analysis, although not limited thereto.

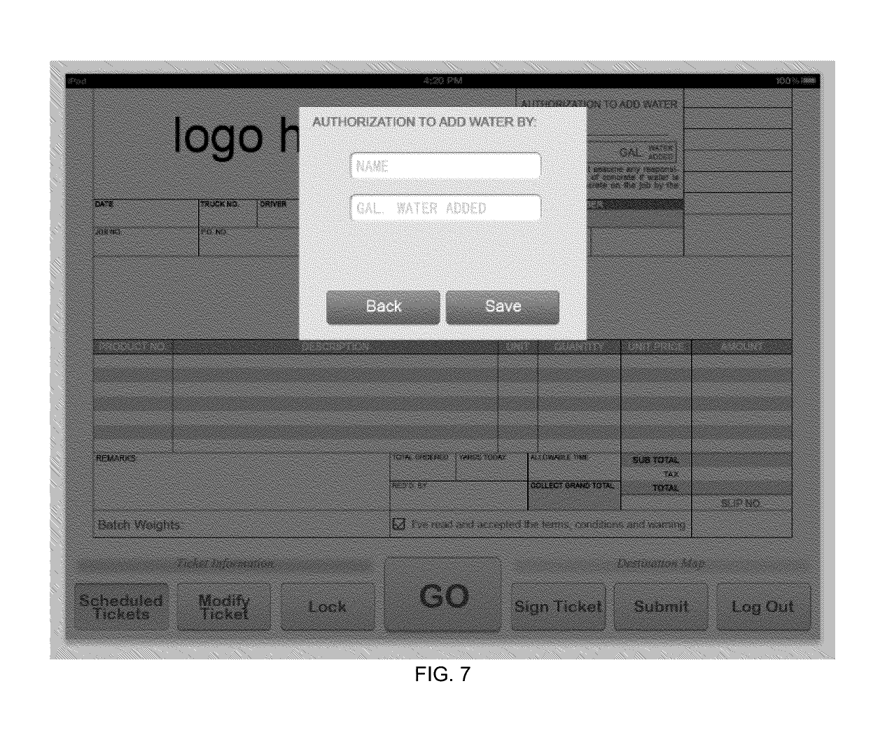

In one embodiment, the driver may record authorization to add water 202. Referring to FIG. 7, shown is one embodiment of the graphical user interface for adding water.

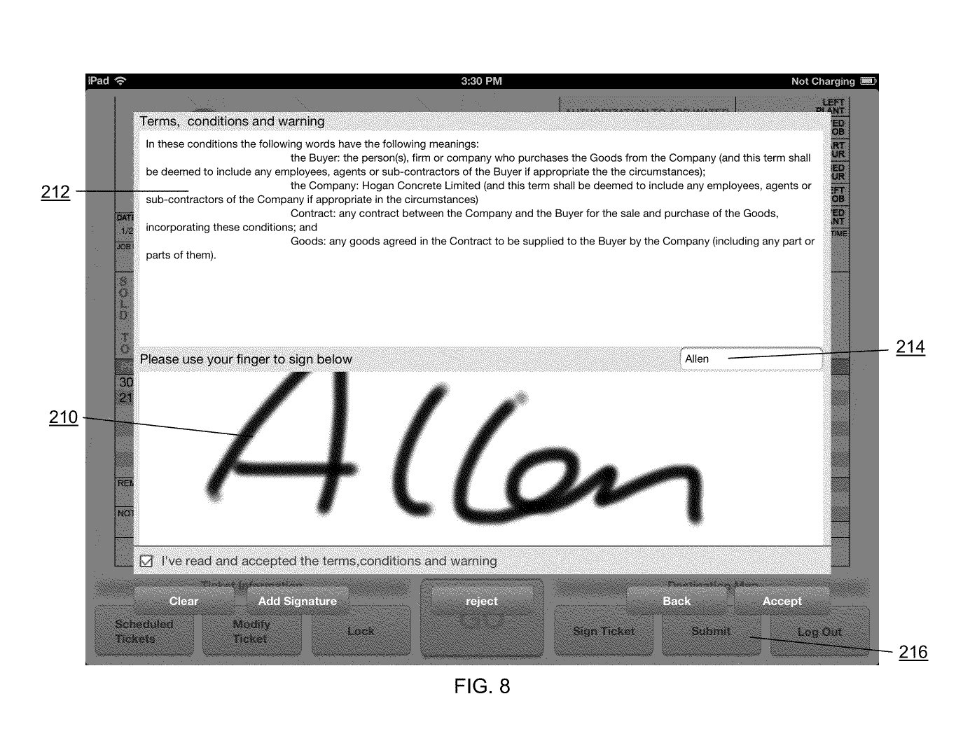

Referring to FIG. 8, shown is one embodiment of the graphical user interface for signing the ticket. The system may provide for the ability to store a signer's name 214 and signature 210, although not limited thereto. In one embodiment, a signer may use a stylus or finger to create a signature on a touch-screen interface. The signer may also be required to accept terms and conditions 212.

In one embodiment, the paperless ticketing client 108 may connect with another system (e.g., paperless ticketing program 100, batching program 104, dispatching program 102, etc.) in order to obtain information regarding authorized signatories. In this way, the signer's name 214 may be selected from a dropdown of available names, although not limited thereto. And once the ticket is signed, a copy may be sent automatically to the signer using stored contact information (e.g., email address, mail delivery address, facsimile number, etc.). Contact information may be stored in the dispatch database 107, although not limited thereto, and the paperless ticketing program 100 may request this information.

After signing the ticket, it may be submitted 216 or uploaded. In one embodiment, “Submit” 216 may validate a network connection (e.g., wifi, cellular data network, etc.) and upload ticket information. The system may provide a notice whether the upload was success and, after ticket upload, the main screen may show the next earliest ticket.

In one embodiment, the system may only submit the ticket once the truck returns to the plant and can utilize an available wifi or other predetermined network. This may allow the system to save expenses on expensive data plans, although not limited thereto. When the paperless ticketing client 108 returns to the plant, it may connect to the plant local network 116 (shown in FIG. 1), although not limited thereto. It may test the connection and upload the ticket. After upload, it may show a message window indicating whether the upload was successful. In the alternative, uploading may not be performed automatically, but a setting may require the user to hit a button to manually upload the ticket. Completed tickets may be sent to the paperless ticketing database 103 for storage, although not limited thereto.

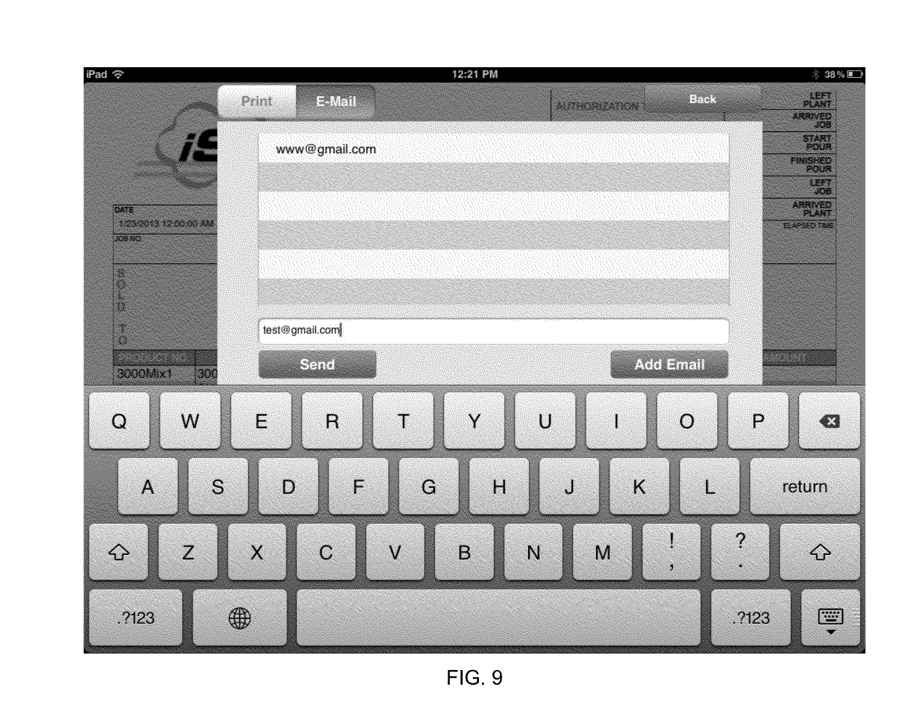

Referring to FIG. 9, the paperless ticketing program 100 may send an email to the customer's email with ticket information. As shown, the user interface may allow the user to enter one or more destination addresses. In one embodiment, the paperless ticketing program 100 may poll the paperless ticketing database 103 for completed tickets and send emails to customer email addresses.

The system may also provide a “Rejected” button for when a delivery is rejected by a customer. The system may provide a comment window to allow the driver and/or customer to add comments regarding the delivery rejection.

Referring to FIG. 10, shown is one embodiment of a batch record. A batch record may include all information about a delivery and may be obtained from the batching program 104 by way of a virtual printer 137, although not limited thereto. Batch records may contain batch weights information, such as both target batch weights and actual batch weights of each constituent in the mix design. Batch records may also contain ticket information such as ticket number, plant name, customer name, mix design name, the water/cement ratio, as well as other information. Traditionally, only actual batch weights are sent to the dispatch system once a batch of a load is completed and full batch records are printed from a batching system upon request. According to the present teachings, however, batch records may be received from the batching computer (e.g., by way of virtual printer, etc.) and made available to the system. Batch records may also be provided in the same format required by a certain project (e.g., DOT requirements, etc.), according to the formatting of the batching computer, although not limited thereto.

The paperless ticketing program 100 and/or paperless ticketing clients 108 may have an alerter 141 (shown in FIG. 4). An alerter 141 may provide alerting functionality to a user of the system. For example, if certain task has not been completed in a predetermined time, the paperless ticketing client 108 may alert a truck driver with the alerter 141. In one embedment, if concrete has not been delivered within a predetermined time (e.g., 1 hour, etc.) of being batched into the truck, the alerter 141 may alert the truck driver that the concrete may be hardening. In another embodiment, the paperless ticketing program 100 may alert a dispatcher that a ticket has not been batched after a predetermined time. Other alerts may include the time between deliveries, the time before completed ticket information is uploaded, etc. One skilled in the art would appreciate the various alerts that may be utilized with the present teachings, which are not limited to any particular embodiment disclosed herein. The tracking of various times involved in the fulfillment of concrete deliveries may facilitate alerts.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A paperless ticketing system for concrete delivery, comprising:
a paperless ticketing program executing on a first computer, the program having a system interface adapted to receive ticket information from a concrete dispatch program and batch information from a concrete batching program;
a storage in electronic communication with the paperless ticketing program, the storage adapted to store the ticket information and the batch information; and
a paperless ticketing client executing on a second computer, the paperless ticketing client in electronic communication with the first computer over a wireless network;
wherein the paperless ticketing client has a graphical user interface adapted to display a ticket comprising the ticket information and the batch information; and
wherein the graphical user interface is adapted to allow a user to edit the ticket to indicate a concrete delivery has been made.

2. The system of claim 1 wherein the batch information comprises batch weight information.

3. The system of claim 1 wherein the paperless ticketing program requests batch information from the concrete batching program at predetermined intervals.

4. The system of claim 1 wherein the paperless ticketing program requests batch information from the concrete batching program after receiving a request from the concrete dispatch program.

5. The system of claim 1 wherein the paperless ticketing program communicates with the concrete batching program using a universal link protocol.

6. The system of claim 1 wherein the paperless ticketing program receives ticket information from the concrete dispatch program at predetermined times.

7. The system of claim 1 wherein after receiving an order the concrete dispatch program sends ticket information to the paperless ticketing program and the paperless ticketing program sends the ticket information to the concrete batching program.

8. The system of claim 1 wherein the graphical user interface is adapted to allow a customer to electronically sign the ticket.

9. The system of claim 1 wherein the system emails a copy of the ticket to a customer.

10. The system of claim 9 wherein the paperless ticketing program obtains the email address of the customer from the dispatch program and the paperless ticketing program sends the email.

11. The system of claim 1 wherein the graphical user interface comprises an application on the second computer.

12. The system of claim 1 wherein the second computer comprises a mobile computer having a touch screen interface.

13. The system of claim 1 wherein the storage is in electronic communication with the paperless ticketing program over the Internet.

14. The system of claim 1 wherein the system interface is adapted for communicating with a plurality of concrete batching programs from different providers.

15. The system of claim 1 wherein the paperless ticketing program is on the same computer as the concrete batching program.

16. The system of claim 1 further comprising a virtual printer program; wherein the virtual printer program creates an electronic copy of a batch record.

17. The system of claim 1 further comprising a ticket server in electronic communication with the paperless ticketing program over the Internet; wherein ticket information is stored on the ticket server.

18. The system of claim 17 wherein the paperless ticketing program sends a pending ticket file to the ticket server after a ticket has been received and sends a completed ticket file to the ticket server after delivery has been completed.

19. The system of 1 wherein the graphical user interface is adapted to display all tickets associated with a concrete truck or a concrete truck driver.

20. A paperless ticketing method for concrete delivery, comprising the steps of:
providing a paperless ticketing program for execution on a first computer;
receiving, with the paperless ticketing program, ticket information from a concrete dispatch program and batch information from a concrete batching program;
providing a paperless ticketing client for execution on a second computer, the paperless ticketing client in electronic communication with the first computer over a wireless network;
displaying, with the paperless ticketing client, a ticket using the ticket information and the batch information;
editing the ticket, with the paperless ticketing client, to indicate a concrete delivery has been made; and
storing the ticket information and the batch information on a storage in electronic communication with the paperless ticketing program over the Internet.

21. The method of claim 20 wherein the batch information comprises batch weight information.

22. The method of claim 20 further comprising the step of searching for a paperless ticketing program in order to associate the paperless ticketing client with the paperless ticketing program.

23. The method of claim 20 further comprising the step of alerting a truck driver with the paperless ticketing client.

24. The method of claim 20 further comprising the step of emailing a copy of the ticket to a customer.

25. The method of claim 20 further comprising the steps of sending a pending ticket file to a ticket server after a ticket has been received; and
sending a completed ticket file to the ticket server after delivery has been completed; wherein the ticket server is in electronic communication with the paperless ticketing program over the Internet.

26. The method of claim 20 further comprising the step of uploading the edited ticket upon returning to a plant.
